(19) United States
(12) Patent Application Publication
(10) Pub. No.: US 2006/0206587 A1
(43) Pub. Date: Sep. 14, 2006

(54) System and method for automatically uploading updates

(75) Inventor: Frank Fabbrocino, Los Angeles, CA (US)

Correspondence Address: DARBY & DARBY P.C., P. O. BOX 5257, NEW YORK, NY, 10150-5257, US

(73) Assignee: Napster LLC, New York, NY (US)

(21) Appl. No.: 11/081,055

(22) Filed: Mar. 14, 2005

(51) Int. Cl. G06F 15/16; G06F 15/173

(52) U.S. Cl. 709/219; 709/224

(57) ABSTRACT

The present invention relates to a method and apparatus for providing a user of an electronic device with an Automatic Upgrade Functionality (AUF), the ability to automatically upgrade software installations with a configurable amount of user interaction and interruption.

### FIELD OF THE INVENTION

This invention generally relates to a system and method of seamlessly updating, correcting, modifying or upgrading software on an electronics device.

### BACKGROUND OF THE INVENTION

Computer software is constantly updated to keep pace with new features, prevent problems from arising, or fix known or recurrent problems. Users exploit several mechanisms, each requiring a certain amount of computer resources, involvement and decision-making on the part of the user, to keep up with available updates. Various methods for updating software include patching and hardware and software upgrades.

Providers typically determine when, how, at what cost, and under what circumstances upgrades are made available. Inevitably, upgrading requires the time and energy of the user device, and some level of user involvement. As a general matter, any increase in time or effort required by the user, or any annoyance experienced due to reduced device functionality while an upgrade occurs, reduces the likelihood that the user actively chooses to upgrade their software, especially if they are not experiencing a problem.

Providers are increasingly providing upgrades via a patch, a discreet portion of computer code downloaded via a network, such as the Internet, as opposed to upgrading via hardware and software upgrades. This is because the process of upgrading via hardware and software upgrades often requires more time than that of a patch as it requires the user to physically load the update onto their user device. The possibility of user error is also increased as greater activity is required on the part of the user to implement upgrades. Alternatively, the process of upgrading via a patch does not require any physical loading of software or hardware by the user. However, upgrading a user's system via the patch does require consideration of the network connection quality, processing capacity of the user device, and user's ability and willingness to properly download and implement the patch.

A patch can be an upgrade, a bug fix, a new hardware driver or update to address new issues such as security, stability or other end-user problems. Most patches are free to download, but ultimately the provider determines which versions of their software are updated for free. In some cases, only registered users may get certain upgrades. At other times the only way to upgrade is to purchase the newer version at a discounted price, which requires reinstallation of the program. Typically, a patch can be installed concurrent with an existing program depending on the supplier and the nature of the patch.

Providers often force, or push, upgrades to the user device and users are typically denied access to the device until upgrades are installed. Alternatively, a provider may prevent a user from closing out of an application until the upgrade is downloaded. When the provider forces downloads of upgrades the user's device typically functions more slowly or not at all until upgrades are downloaded. Alternatively, users may request, or pull, upgrades by accepting them upon notification provided by the provider that upgrades are available. The download of the upgrade is typically contemporaneous with the user's request and consumes computer resources causing delay in the device's utility to the user.

Generally, users must conform to parameters set by the providers if they are to obtain upgrades. The prior art method of receiving upgrades is problematic for several reasons. The provider typically does not take into account that the user's device is slowed while the download takes place and that the user's experience while using their device is negatively impacted by a delay caused by downloading an upgrade. Alternatively, when upgrades are pulled, users are required to make decisions about when to suffer a delay on the user device on a case-by-case basis. Further, users pulling upgrades are often required to determine the correct upgrade for their system with no or little knowledge or guidance. In either case, the provider may limit the size of the upgrade to be downloaded or provide the upgrade in serial form to reduce the delay experienced by the download.

In situations where the provider forces the user to accept updates, the user typically has no choice as to when or how such upgrades occur. The user experiences interruption in the functionality of the user device and, worse still, the delay may be unexpected and/or frustrate the user's use of their device. In situations where the upgrade is requested by the user, they typically have limited options to refuse a download. In the event that the user chooses to download the upgrade, the upgrade starts downloading to the user device immediately and, during the time of the upgrade, the user experiences reduced functionality of the user device. Some users have developed a habit of choosing not to upgrade due to the temporary interruption in the use of the device. The burden of upgrading to resolve problems often exacerbates the frustration of the user experiencing an underlying problem and makes finding a less intrusive means of providing upgrades to clients and users desirable. In the long term, failure to voluntarily upgrade acts as a detriment to providers, clients and users, as upgrades allow users to experience the best product the provider has to offer, resolve problems, and prevent problems from arising.

There exists a need to provide users with a less burdensome means of upgrading their devices by providing users with the means to select when and in what manner downloading can occur that reduces the interruption of their use of their device.

### SUMMARY OF THE INVENTION

The present invention relates to a method and apparatus for providing a user of an electronic device with an Automatic Upgrade Functionality (AUF), the ability to automatically upgrade software installations with a configurable amount of user interaction and interruption. That is, an upgrade is configured to provide full or limited notification of the upgrade to the user or is completely silent.

The present invention augments existing methods for patch, soft and hard upgrades by providing an upgrade facility with more control over the user experience. AUF provides an innocuous upgrade service to users and/or clients compared to conventional methods, where users and/or clients are forced to quit the application, download an installer program and then run it manually to upgrade their application, or are burdened by an undesirable reduction in the use of their device. AUF provides for a less intrusive way for providers to supply users and/or clients with upgrades, and for users and/or clients to implement those upgrades. Using AUF, the user/client pre-selects the parameters under which they prefer receiving upgrades, or the client/server determines the best time to download an upgrade.

There are several steps in the AUF process. The AUF program can be stored on either the client or the server. The user's device connects to the server using an existing connection protocol. As part of the server response to the connection, the server and/or client transmit AUF data. The user may or may not access the AUF to set personal preferences using several available parameters to control the AUF process. The parameters can be preset to automatically upgrade the software or to upgrade the software according to user preference. In one embodiment, any upgrade downloaded according to the AUF parameters is implemented automatically at a time when the user is not otherwise using the device. Alternatively, any upgrade downloaded according to the AUF parameters is implemented automatically when the software is launched. In an embodiment, AUF parameters are preset to automatically upgrade the device with upgrades that are available from secure sources at times when the client is used the least.

In one embodiment, to download an update, the user device connects to the download server and downloads the upgrade using an URL and priority parameters. The client verifies that the downloaded upgrade is unchanged and prepares the upgrade to be launched automatically, or at the next client startup. Verification uses the checksum or other security parameter returned during initiation to ensure that the downloaded update is correct. If the parameters are set to notify the user, the user is notified accordingly.

One embodiment has a single point of execution. For example, a small launch executable can be the main entry point for users to run the application. The launcher, when run, reads a known registry key and allows the current client executable to run. When a new version of the software is downloaded successfully, the registry key is updated accordingly. For example, the launcher can be called “Client.exe” and the client executable is called “Client-<version>.dat”, where “<version>” is the version number of the executable.

In one embodiment, the download request and the user notification are handled outside of the main client thread, therefore the user is free to use the client while the AUF process is completed. Download priority is implemented by setting a thread priority control. Therefore, by virtue of the thread scheduler, the download thread gets more or less CPU time to complete the download depending on the settings.

In an embodiment, the request for software updates automatically indicates the current version and any patch version used by the user device issuing the request. The server and/or the client responds by comparing the version information with available updates to determine whether or not to upgrade the client.

Verification that the download is successful utilizes a checksum or similar program. The checksum is used to prevent corrupted downloads. For improved security, a cryptographic hash (e.g. MD5 or SHA1) or other similar security measure can be used.

In an embodiment, because AUF is invoked multiple times for the lifetime of a client installation, “old” computer code can collect on the user's device. To prevent this from becoming a resource leak and to prevent unnecessary use of storage space, only the most recently used version is retained. For example, a software upgrade from version 3.6 to 3.7, and then 3.7 to 3.8, results in removal of the 3.6 version from the device. When version 3.8 is upgraded to 3.9, the 3.7 version is removed. Alternatively, prior versions are deleted in accordance with a predetermined amount of time or are stored elsewhere.

In an embodiment, AUF can download an update obscured to prevent it from being considered a security risk. The executable can be packaged as a .CAB archive file or other similar file and can be given a specific name to identify the version upgrade.

Downgrades can also be performed using the present invention. Users have the option to refuse upgrades, either in whole, or only for specific applications, thereby selectively maintaining pre-updated material. This feature is especially useful where the compatibility of a program with other programs is lost upon installation of an upgrade, or where the user has a preference for a particular version of the application.

In one embodiment, upon initiation of the AUF, the server notifies the user device that an upgrade is available. This is done via a defined protocol between the user device and the server.

In one embodiment, registry settings include an option to enable or disable the AUF and checksum verification; and indicate the current and previous versions of the client. In one embodiment, hidden registry settings pertaining to AUF are also created.

In one embodiment, little or no user intervention is required, and the user continues to use the device and software uninterrupted and the actual upgrade occurs at the next launch. The update method includes automatically downloading an upgrade in the background so that the next time the user starts their device the software upgrade is automatically loaded and the software upgraded.

It is an object of this invention to provide the user with the greatest amount of control possible, such that they are encouraged to upgrade despite interruption in the use of their computer.

### BRIEF DESCRIPTION OF THE DRAWINGS

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a diagram of the present invention;

FIG. 2 is a flow chart of an embodiment of a method of the present invention; and

FIG. 3 is a diagram illustrating an embodiment of the service parameters of the present invention.

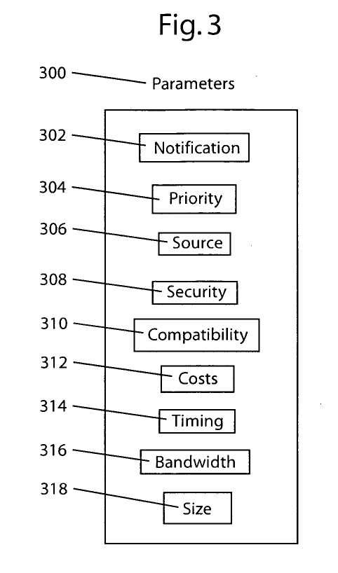

### DETAILED DESCRIPTION OF THE EMBODIMENTS

The system and method provides a user of an electronic device with an AUF, that is, the ability to automatically upgrade software installations with a configurable amount of user interaction and interruption.

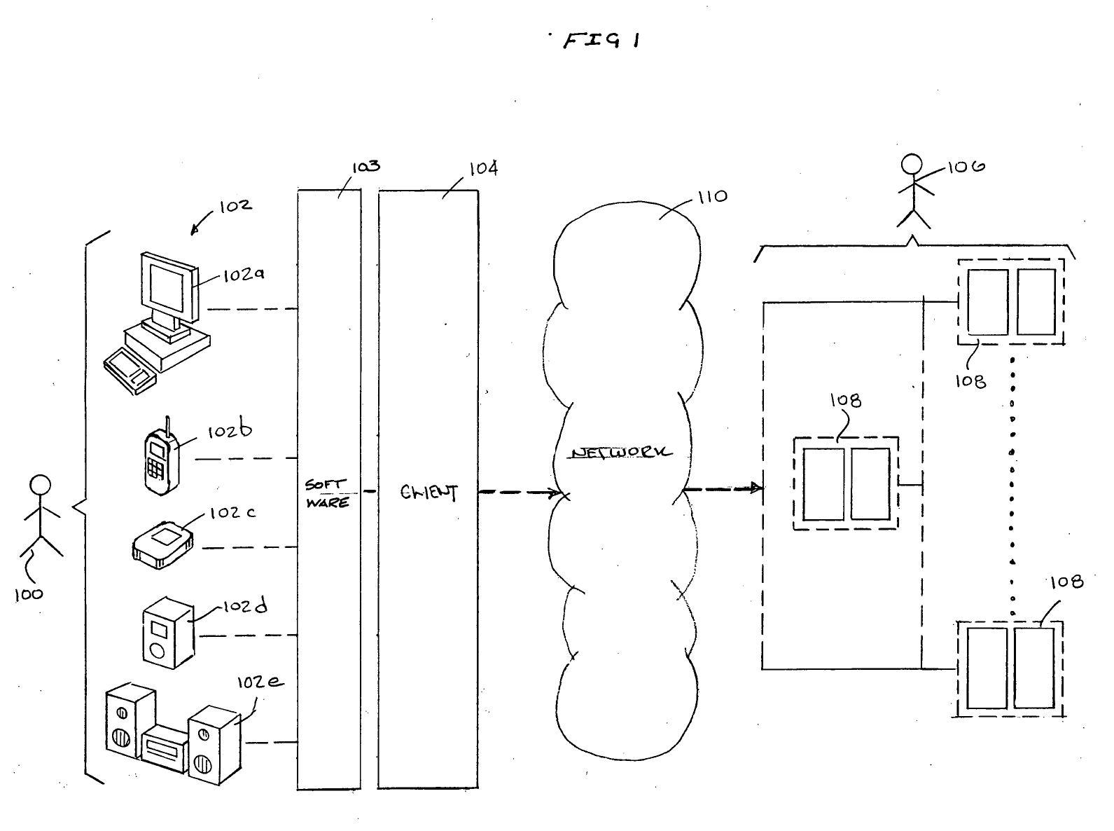

FIG. 1 illustrates a basic system of the present invention. A user 100 utilizes a device 102 connected over a network 104 to a provider's 106 system, typically including one or more servers 108. The user's devices 102 can include a computer 102a, a cellular telephone 102b, a PDA/pager/Blackberry® 102c, an MP3 player 102d, or entertainment device 102e, including stereos, DVD/VHS players, game systems (e.g. PS2®, X-Box®) or any networked device both stationary or portable. User device 102 can, in one embodiment, run a client 104 which can be the software allowing the user 100 to access server 108 and also run software 103. The user 100 can connect to the network 110 using any method known in the art, including telephone, DSL, cable, wireless and satellite. Network 110 can be a LAN, WAN and include the Internet. The provider's 106 system can include one or more servers 108 to run the service accessed by user 100. The provider 106 can distribute the functionally, across multiple servers, each server handling one of more specific tasks, or each server handling all tasks.

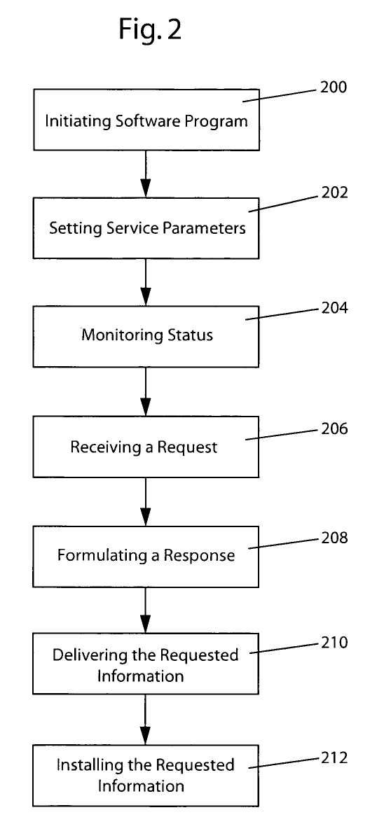

FIG. 2 illustrates a method for transmitting electronic information over a computer network. The method for providing an update to a user device 102 includes the steps of initiating the client 104 on a user device 102 (step 200). The user 100 or the client 104 can initiate the software program 103 by downloading the program from the server 108 via the network 110, by obtaining the software program from another source, or by launching the client 104.

Another step is the setting one or multiple of the available service parameters (step 202). The service parameters 300 can be stored either on at least one of the client 104 and server 108. The parameters 300 are understood by the client 104 and server 108. The user 100, the client 104, the server 108, can set the parameters 300 on the client 104 and/or server 108. Alternatively, the parameters 300 can be preset as part of the AUF upon initiating the client 104 or may be preset and later altered according to the user's 100 preferences. In one embodiment, the user 100 is not involved, and the AUF functions automatically according to service parameters 300. Other embodiments include some of or all of the following parameters 300 as set by one of the user 100 or the client 104.

A notification parameter 302 determines the amount of notification to the user 100. In one embodiment, the notification parameter 302 is set to either notify or not to notify the user 100 under various circumstance, including but not limited to those set forth below. The notification parameter 302 can be set to notify user 100 that the upgrade is available, to request approval before downloading an upgrade, that the upgrade download was successful, to indicate the download source and/or security, and to notify the user 100 of a need for further instruction regarding particular downloads. The client 104 can also be notified. The notification parameter 302 can be set to include notification of, among others, only certain types of upgrades, upgrades provided by particular providers, upgrades that are provided by a secure source, upgrades exceeding a certain size, or upgrades expected to require more than a certain amount of time to download. Additionally, the notification parameter 302 can be set to request notification at specific times, or a delayed summary notification of all upgrade downloads over a specified time.

Priority parameter 304 is set to determine the priority with which downloads occur and allows user 100, client 104 and/or server 108 to set a range of priority for downloading requested information. For example, downloads of greater priority result in faster download performance with the understanding that such downloads have the highest probability that the user 100 can be disturbed. Downloads of lower priority result in slower download performance, but are less likely to disturb the user 100.

Source parameter 306 provides the user 100 or instructs the client 104 of the option to download depending on the available source. The source parameter 306 can be set to only download from particular sources, or where download security is also available. For example, if the download is from an undesirable unsecured source, the download does not occur. In the instance that a download is selected on the basis that its source is unsecured or otherwise undesirable, the option to have the client 104, either automatically and/or upon notice to the user 100, locate a provider-approved or a secure source of the upgrade is available.

Security parameter 308 provides the user 100 and/or the client 104 the option to download a checksum, indicating that a checksum is used to verify that the download was not corrupted. This option is available using methods known in the art, such as by using either MD5 or SHA hashes.

Compatibility parameter 310 can be set to provide one or more of the user 100, client 104 and server 108 the option determine the compatibility of available downloads with other programs located on user device 102, and the ability to refuse to download those upgrades and/or download upgrades accordingly. In one embodiment, another provider's 106 information is used to assess any conflicts between existing software on the user device 102 and the suggested download. This embodiment results in two downloads, one to upgrade for each software package, so that they are compatible.

Costs parameter 312 can be set values for prompting certain responses from the user 100 and or the client 104 when there is a cost associated with the download and/or according to the amount of the cost. In one embodiment, the user 100 and or the client 104, sets up an automatic account on the client 104 or through a third party so that payment is made and the upgrade is downloaded.

Timing parameter 314 can be set to request that downloads only occur at specific times. In an embodiment, the client 104 can be set to independently determine optimal times for download, such as when the client is used the least. Alternatively, the client 104 requests to re-initiate contact with the provider 106 and/or the server 108 in order to download upgrades at a certain time. For example, where software 103 did not upgrade so that the user's 100 use of software 103 may be less likely to be impeded in the short term, the client 104 can note the URL of the site where the upgrade download is available and return to that site in accordance with the parameters set for AUF.

Bandwidth parameter 316 can be set to request that an upgrade be delivered using only a certain amount of available bandwidth, or not exceeding a certain amount of bandwidth. This feature is useful for devices 102 that need to keep a certain amount of bandwidth available for other uses.

Size parameter 318 can be set to request that an upgrade be delivered according to size, or not exceeding a certain size. In one embodiment, the client 104 requests information regarding the download size and requests that the upgrade be sent as one large file or multiple small files delivered one at a time.

Returning to FIG. 2, another step can be monitoring the status of the client 104 by at least one of the client 104 and the server 108 via the network 110 (step 204). Monitoring the status of the client 204 can occur all the time, can occur at times determined by setting the service parameters 202, can occur automatically when the client 104 launches, when the server 108 and client 104 connect to each other via the network 110, and anytime the server 108 and client 104 connect to the network 110. Monitoring the status of the client 204 can include monitoring selected or all sources available via the network 110 for available updates and any potential use for the available updates by the client 104.

A request for information is sent and received by the client 104 or the server 108 (step 206). In one embodiment, the request to obtain information can be sent from the client 104 to the server 108 via the network 110 automatically by the client 104 or can be sent under the direction of the user 100. In an embodiment, the request to obtain information is sent and/or received in accordance with the parameters 300.

One of the client 104 and the server 108 formulate a response to requests for information (step 208). A response is formulated according to the set service parameters 202. The requested information is then delivered to the requesting client 104 or server 108 via the network 110 (step 210).

The delivery of the requested information 210 is made according to the set service parameters 300. In one embodiment, the software modification is delivered in encrypted and/or compressed form. In another embodiment, the delivery of the requested information 210 is accompanied by the delivery of instructions to the user for the proper installation of the update.

Requested information is installed (step 212) by the client 104, the user 100 and/or the server 108. In one embodiment, proper installation of the requested information on the client 104 is ensured by the client 104 and/or the server 108.

While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature.

I claim:

1. A method for transmitting electronic information over a computer network comprising the steps of:
setting a service parameter;
monitoring a status of a software program on a user device;
receiving a request for information;
formulating a response to the request using the service parameter;
delivering the requested information pursuant to the service parameter; and
installing the requested information pursuant to the service parameter.

2. The method of claim 1, wherein the step of monitoring the status of a software program on a user device comprises the steps of:
monitoring the software by at least one of the client and the server; and
comparing the status of the software program on the user device with a second software program.

3. The method of claim 1, further comprising the step of providing notice to at least one of a user, the client, the server, or the provider regarding one or more of the setting, monitoring, formulating, delivering, and installing steps.

4. The method of claim 1, further comprising the steps of:
installing the software program;
starting the software program; and
setting service parameters according to a preference.

5. The method of claim 1 wherein the monitoring step comprises the step of detecting availability of the requested information.

6. The method of claim 7 wherein the monitoring step further comprises the step of detecting availability of the requested information by one of user, a client, a server, and a provider.

7. The method of claim 1 wherein the monitoring step comprises detecting appropriateness of the requested information for installation.

8. The method of claim 1, wherein the formulating step comprises the steps of:
accessing the service parameters;
interpreting the service parameters; and
applying the service parameters to the response for information.
